(19) United States
(12) Patent Application Publication
(10) Pub. No.: US 2010/0012292 A1
(43) Pub. Date: Jan. 21, 2010

(54) TRAP APPARATUS, EXHAUST SYSTEM AND PROCESSING SYSTEM USING SAME

(75) Inventor: Ryoji YAMAZAKI, Nirasaki-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: TOKYO ELECTRON LIMITED, Minato-ku (JP)

(21) Appl. No.: 12/569,935

(22) Filed: Sep. 30, 2009

Related U.S. Application Data
(63) Continuation of application No. PCT/JP08/55678, filed on Mar. 26, 2008.

(30) Foreign Application Priority Data
Mar. 31, 2007 (JP) 2007-095823

(51) Int. Cl. F25B 29/00; B01D 5/00; B01D 8/00

(52) U.S. Cl. 165/61; 96/399

(57) ABSTRACT

Provided is a trap apparatus, disposed in an exhaust passage 22 for discharging an exhaust gas from a processing chamber 10 for processing a wafer W, thereby to trap exhaust from the exhaust gas, so that the exhaust trapped by a trap element can be efficiently removed to regenerate the trap element. The trap apparatus includes a housing 42 disposed in the exhaust passage, a trap element 48 disposed in the housing for trapping the exhaust, a trap heating unit 54 for heating the trap element, a coolant introducing unit 60 for introducing a coolant into the housing, a coolant discharging unit 62 for discharging the coolant from the housing, and a controller 88 which performs a control to introduce the coolant from the coolant introducing unit into the housing, while the trap element being heated by the trap heating unit, to remove the exhaust trapped by the trap element.

This application is a Continuation Application of PCT International Application No. PCT/JP2008/055678 filed on Mar. 26, 2008, which designated the United States.

### FIELD OF THE INVENTION

The present invention relates to a trap apparatus for capturing (trapping) exhaust in an exhaust gas from a processing apparatus which performs, e.g., a film forming process on a semiconductor wafer or the like to manufacture a semiconductor device. More specifically, the present invention relates to a trap apparatus capable of regenerating a trap element by removing the exhaust adhered to the trap element when necessary. Moreover, the present invention also relates to a processing system and an exhaust system including the trap apparatus.

### BACKGROUND OF THE INVENTION

In general, a trap apparatus is installed in an exhaust passage for exhausting an internal atmosphere in a processing apparatus which performs a preset process such as a film forming process on a semiconductor wafer or the like. The trap apparatus is positioned on a front end side of a vacuum pump. In the trap apparatus, exhaust such as an unreacted processing gas and/or a reaction by-product in an exhaust gas from a processing chamber of the processing apparatus is captured by a trap element within the trap apparatus. The trap apparatus functions to remove the exhaust captured by and adhered to the trap element, thereby regenerating the trap element.

In a processing system having a single trap apparatus, an operation of the processing system is stopped when a certain amount of exhaust is captured by the trap element, and the adhered exhaust is removed by cleaning the trap element with cleaning water.

Disclosed in Japanese Patent Laid-open Application Nos. 2001-323875 and 2004-111834 is a trap apparatus including two trap elements movable between one trapping region and two regeneration regions provided at both ends of the trapping region. In such a trap apparatus, if the first trap element located in the trapping region captures a certain amount of exhaust such as a reaction product in the exhaust gas, the first trap element is moved into one regeneration region and a regenerating process is performed therein. While the first trap element is capturing the exhaust in the trapping region, the second trap element is located in the other regeneration region and the exhaust adhered to the second trap element is washed away by cleaning water. If the second trap element is then moved into the trapping region, the first trap element is transferred into the regeneration region.

By using the two trap elements alternately as described above, wafers can be consecutively processed without having to stop the processing apparatus, so that an operating rate of the processing apparatus can be improved.

In the above-described configuration in which the trap element is cleaned just by pouring the cleaning water, the exhaust adhered to the trap element may not be sufficiently removed, resulting in a failure to regenerate the trap element sufficiently.

Moreover, in the trap apparatus including the two alternately switchable trap elements, the trap elements are slidingly moved on a housing inner wall. Thus, when the trap elements make sliding motions, the exhaust gas or the cleaning water may leak from a sliding portion, even if a sealing member is provided at the sliding portion.

### SUMMARY OF THE INVENTION

In view of the foregoing, the present invention has been conceived to solve the above-mentioned problems.

The present invention provides a trap apparatus capable of sufficiently removing an exhaust adhered to a trap element, thus enabling a successful regeneration of the trap element.

The present invention further provides a trap apparatus capable of preventing, even in case it has more than one trap element, a leakage of an exhaust gas or the like when the trap elements are switched.

Still further, the present invention also provides an exhaust system and a processing system including the trap apparatus.

The present inventors conducted many researches on the removal of the exhaust adhered to the trap element. Based on a difference in linear expansion coefficient between the adhered exhaust and the trap element for capturing the exhaust, the inventors have found out that the adhered exhaust (by-product) can be physically destructed (broken up) and removed away due to the difference in linear expansion coefficient therebetween and a heat contraction rate by way of rapidly cooling both the adhered exhaust and the trap element. Based on this knowledge, the inventors have conceived the present invention.

In accordance with a first aspect of the present invention, there is provided a trap apparatus provided in an exhaust passage for discharging an exhaust gas from a processing chamber which processes a target object, and configured to capture an exhaust from the exhaust gas, the apparatus including: a housing installed in the exhaust passage; a trap element provided in the housing, for capturing the exhaust; a trap heating unit for heating the trap element; a coolant introducing unit for introducing a coolant into the housing; a coolant discharging unit for discharging the coolant from the housing; and a controller for controlling the trap heating unit and the coolant introducing unit such that the coolant is introduced into the housing by the coolant introducing unit in a state the trap element is heated by the trap heating unit to remove the exhaust captured by the trap element.

As stated, when the exhaust adhered to the trap element is removed, the trap element and the adhered exhaust are rapidly cooled by the coolant introduced from the coolant introducing unit. Due to the difference in linear expansion coefficient between the trap element and the adhered exhaust, and a heat contraction rate, the adhered exhaust can be physically broken up and clearly removed. Thus, the regeneration of the trap apparatus can be successfully carried out.

In a preferred embodiment, a transparent irradiation window may be provided at the housing, and the trap heating unit may include an infrared heater provided on an external side of the irradiation window outside the housing. Further, in a preferred embodiment, an anti-adhesion shutter for preventing an adhesion of the exhaust to a surface of the irradiation window may be movably installed on an internal side of the irradiation window inside the housing. The trap heating unit may include a resistance heater provided at the trap element.

Moreover, in a preferred embodiment, the coolant introducing unit may have a coolant inlet opening provided at a ceiling portion of the housing, and the coolant is injected to the trap element from the coolant inlet opening. In a preferred embodiment, the coolant discharging unit may be installed in a bottom portion of the housing, and an opening/closing valve configured to be opened and closed may be provided at a coolant discharge opening of the coolant discharging unit. Preferably, the opening/closing valve includes a valve body, a flange-shaped valve seat provided at an outer periphery of a valve opening to accommodate the valve body thereon, and a sealing member for airtightly sealing a gap between the valve seat and the valve body is provided a the valve seat.

A cooling jacket may be provided at an outer periphery of the housing. An atmospheric pressure restoring gas introducing unit may be provided to introduce an atmospheric pressure restoring gas into the housing. The trap element may have fins.

The fins may be rotatable. The fins may be made of a material selected depending on a kind of the exhaust.

In accordance with a second aspect of the present invention, there is provided an exhaust system including: an exhaust passage for discharging an exhaust gas from a processing chamber for processing a target object; the trap apparatus of the first aspect installed in the exhaust passage; an exhaust gas abatement equipment for removing a harmful substance in the exhaust gas that has passed through the trap apparatus; and an exhaust pump installed at the exhaust passage, for suctioning an atmosphere within the processing chamber. Preferable, the trap apparatus may be installed at an attachment pipe provided in the exhaust passage, and the attachment pipe may be curved in a direction of gravity such that the trap apparatus is located at a position lower than a joint portion of the exhaust passage to the attachment pipe.

In accordance with a third aspect of the present invention, there is provided an exhaust system including: an exhaust passage for discharging an exhaust gas from a processing chamber for processing a target object; two or more attachment pipes installed on the exhaust passage in parallel to each other; the trap apparatus of the first aspect installed in each attachment pipe; a switching valve provided at each of a branch part and a junction part of the attachment pipes, for allowing at least one of the attachment pipes to communicate with the exhaust passage, while allowing at least one of the other attachment pipes to be isolated from the exhaust passage; an exhaust gas abatement equipment for removing a harmful substance in the exhaust gas that has passed through the trap apparatus; an exhaust pump installed at the exhaust passage, for suctioning an atmosphere within the processing chamber; and a switching controller for controlling the trap apparatuses and the switching valve such that an operation for trapping the exhaust from the exhaust gas is performed in said at least one of the trap apparatuses while an operation for removing the adhered exhaust from said at least one of the other trap apparatuses is being performed.

Since the trap apparatuses are switched by the switching valve in this configuration, it is not necessary to provide a sliding sealing portion, so that a leakage of the exhaust gas, the coolant (cleaning water) or the like can be suppressed. Moreover, the processing system can be operated consecutively.

In a preferred embodiment, a valve heating unit for heating the switching valve may be provided at the switching valve to prevent an adhesion of the exhaust in the exhaust gas to the switching valve. Further, a cooling jacket may be provided to cool the branch part and the junction part. Each attachment pipe may be curved in a direction of gravity so as to locate the trap apparatus, which is provided in the corresponding attachment pipe, lower than a joint portion of the attachment pipe to the exhaust passage.

In accordance with the present invention, there is provide a processing system including: a processing apparatus having a processing chamber for processing a target object; and the exhaust system in accordance with the second and the third aspects of the present invention.

### BRIEF DESCRIPTION OF THE DRAWINGS

FIG. 1 is a schematic configuration view showing a first example of a processing system using a trap apparatus in accordance with the present invention.

FIG. 2 sets forth a side view of the trap apparatus in accordance with the present invention.

FIG. 3 depicts a partial cross sectional top view showing the trap apparatus installed in an exhaust system in accordance with a first embodiment of the present invention.

FIG. 4 provides a perspective view of a trap element accommodated in the trap apparatus.

FIGS. 5A and 5B offer diagrams to describe an operation of a discharging valve installed in a coolant discharging unit.

FIG. 6 presents a flowchart to describe an entire operation of the processing system including the gas exhaust system equipped with the trap apparatus in accordance with the first embodiment of the present invention.

FIG. 7 is a partial cross sectional top view of trap apparatuses installed in an exhaust system in accordance with a second embodiment of the present invention.

FIG. 8 depicts a flowchart to describe an entire operation of a processing system including the exhaust system equipped with the trap apparatuses in accordance with the second embodiment of the present invention.

### DETAILED DESCRIPTION OF THE EMBODIMENTS

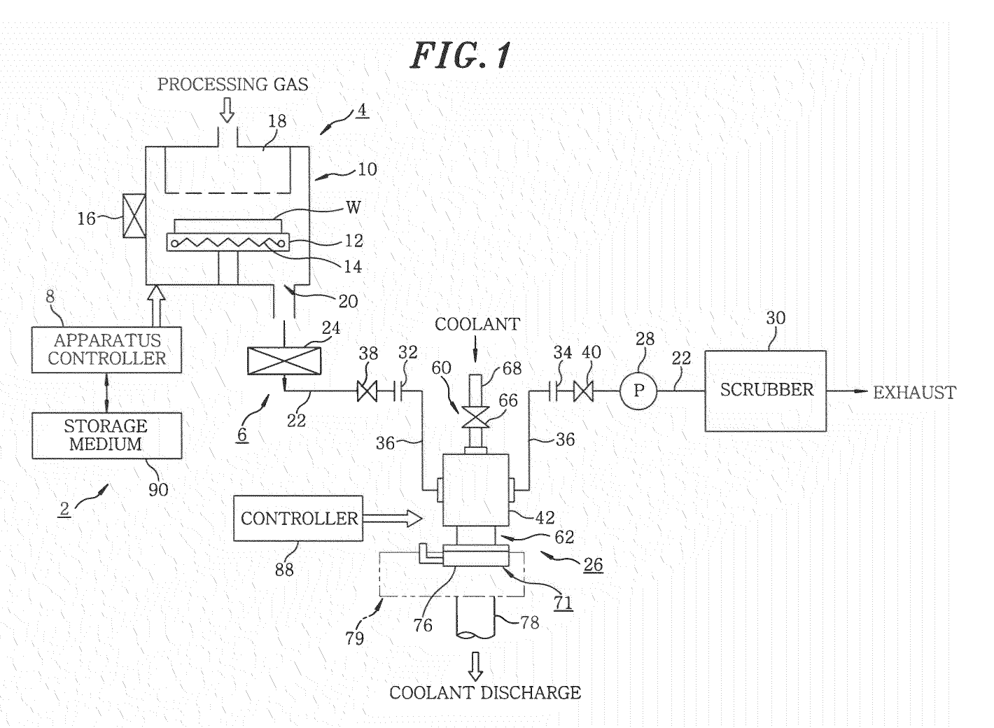

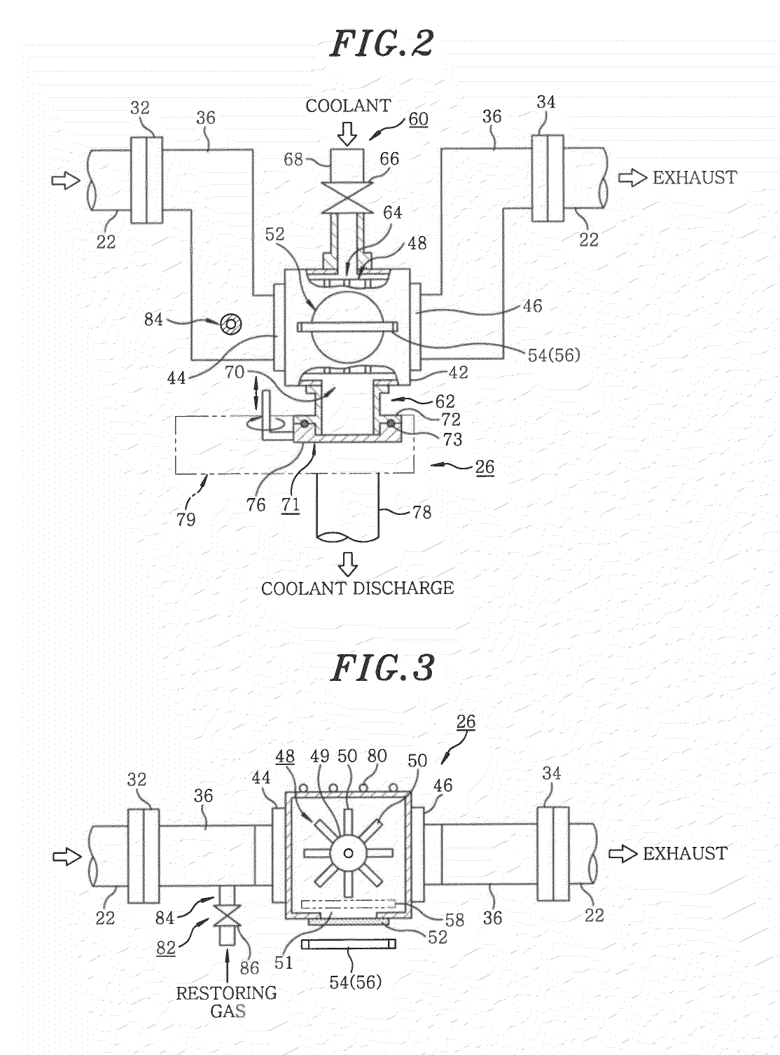

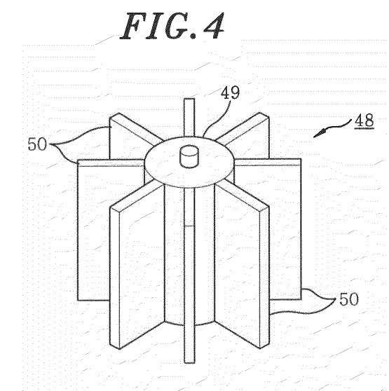

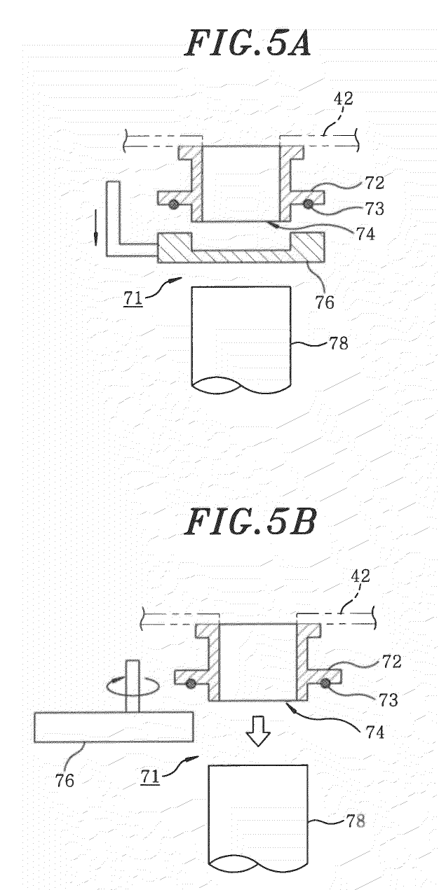

Hereinafter, a trap apparatus in accordance with the present invention, an exhaust system using the trap apparatus and a processing system using the exhaust system in accordance with a first embodiment of the present invention will be described in detail with reference to the accompanying drawings. FIG. 1 is a schematic configuration view showing a first example of the processing system using the trap apparatus in accordance with the present invention. FIG. 2 sets forth a side view of the trap apparatus in accordance with the present invention, and FIG. 3 depicts a partial cross sectional top view of the trap apparatus installed in the exhaust system in accordance with the first embodiment. Further, FIG. 4 is a perspective view of a trap element accommodated in the trap apparatus, and FIGS. 5A and 5B provide diagrams for describing an operation of a discharging valve installed in a coolant discharging unit.

(Overall Configuration of the Processing System)

First, the processing system will be first explained with reference to FIG. 1. As illustrated in FIG. 1, the processing system 2 mainly includes a processing apparatus 4 for performing a predetermined process such as a film forming process or an etching process on a semiconductor wafer W which is a target object to be processed; and an exhaust system 6 for exhausting an atmosphere inside the processing apparatus 4 while maintaining the inside of the processing apparatus 4 at a certain pressure level. The entire operation of the processing system including the processing apparatus 4 and the exhaust system 6 is controlled by an apparatus controller 8 having, e.g., a computer.

In the present embodiment, the processing apparatus 4 is a single wafer processing apparatus which processes wafers one by one. The processing apparatus 4 has a cylindrical processing chamber 10 made of an aluminum alloy. A mounting table 12 for mounting the wafer W thereon is provided in the processing chamber 10. A resistance heater 14 serving as a heating unit is installed in the mounting table 12 so that the wafer W can be heated to and maintained at a predetermined temperature. Here, a heating lamp or the like may also be used as the heating unit.

The mounting table 12 is also provided with a vertically movable lift pin (not shown) for moving the wafer W up and down while supporting the wafer W when the wafer W is loaded or unloaded. Provided at a sidewall of the processing chamber 10 is a gate valve 16 which is opened and closed when the wafer W is loaded and unloaded. Further, a shower head 18 serving as a gas introducing unit, for example, is provided in a ceiling portion of the processing chamber 10 to introduce various processing gases into the processing chamber 10. A gas nozzle may be used as the gas introducing unit instead of the shower head 18. An exhaust port 20 for exhausting an atmosphere within the processing chamber 10 is provided at a bottom portion of the processing chamber 10. Further, the processing apparatus 4 is not limited to the single-wafer type, and it may be a batch type processing apparatus capable of processing a number of wafers at one time.

### Configuration of the Exhaust System in Accordance with a First Embodiment

Now, the exhaust system 6 in accordance with the first embodiment will be explained. The exhaust system 6 of the first embodiment includes an exhaust passage 22 connected to the exhaust port 20 of the processing chamber 10, and the atmosphere within the processing chamber 10 can be exhausted as an exhaust gas. The exhaust gas contains gaseous exhaust such as an unreacted residual gas and a reaction by-product generated when the wafer W is processed.

Installed on the exhaust passage 22 in sequence from the upstream side are a pressure control valve 24 having a passage blocking function and a valve-opening controlling function; a trap apparatus 26 for capturing and trapping the exhaust in the exhaust gas; an exhaust pump 28 for suctioning the atmosphere within the processing chamber 10; and an exhaust gas abatement equipment 30 for removing harmful substances in the exhaust gas that have passed through the inside of the trap apparatus 26. Further, an order of the above-described components installed on the exhaust passage 22 is not limited to the aforementioned example. In the present embodiment, a vacuum pump for evacuating in the processing chamber 10 to a vacuum is used as the exhaust pump 28.

An attachment pipe 36 is installed on a horizontally extending portion of the exhaust passage 22. The attachment pipe 36 is attached to the exhaust passage 22 by means of bolts via flanges 32 and 34 provided at an upstream portion and a downstream portion thereof, respectively. The trap apparatus 26 is installed between the upstream portion and the downstream portion of the attachment pipe 36. The attachment pipe 36 is curved downward so as to have a U-shape (or a square bracket shape) as a whole. That is, the trap apparatus 26 is positioned vertically lower than the horizontally extending portion of the exhaust passage 22 connected to the attachment pipe 36.

Opening/closing valves 38 and 40 are installed on the exhaust passage 22 upstream of the flange 32 and on the exhaust passage 22 downstream of the flange 32, respectively, so as to block the exhaust passage 22. That is, the gas exhaust passage 22 can be blocked by the opening/closing valves 38 and 40 when maintenance of the trap apparatus 26 is performed, for example.

(Configuration of the Trap Apparatus)

Now, a configuration of the trap apparatus 26 will be described. As illustrated in FIGS. 2 and 3, the trap apparatus 26 has a box-shaped housing 42 installed in the attachment pipe 36 constituting a part of the exhaust passage 22. The housing 42 is made of, for example, stainless steel. The upstream portion of the attachment pipe 36 is connected to a gas inlet 44 provided at one side of the housing 42 and the downstream portion of the attachment pipe 36 is connected to a gas outlet 46 provided at the opposite side of the housing 42. In this configuration, the exhaust gas is allowed to flow through the inside of the housing 42.

A trap element 48 for capturing (trapping) the gaseous exhaust in the exhaust gas is accommodated in the housing 42. To elaborate, in the shown example, the trap element 48 has 8 fins 50 arranged around a rotation shaft 49 (see FIG. 4), and the exhaust is adhered to and captured by the surfaces of the fins 50 as the fins 50 are rotated by a driving mechanism (not shown). In this way, by rotating the fins 50, the exhaust can be uniformly captured on the entire surface of the fins 50. The fins 50 are made of, for example, a corrosion resistant material such as stainless steel or hastelloy (product name), or a ceramic material such as Si₃N₄ having a high resistance to a thermal shock, so that corrosion of the fins 50 caused by the captured exhaust can be prevented.

An axial direction of the rotation shaft 49 of the fins 50 may be parallel to, e.g., a flow direction of the exhaust gas without being limited to a direction perpendicular to the flow direction of the exhaust gas as in the shown example. The number and shape of the fins 50 and the stage number of the trap element 48 may not be limited to the shown example. For example, trap elements 48 may be arranged in multi-stages, e.g., three stages, along the direction of the exhaust gas flow, and rotational speeds of those trap elements 48 may be set differently to, for example, a low, an intermediate and a high level.

A large circular opening 51 is provided in another sidewall of the housing 42, and an irradiation window 52 made of, e.g., a transparent quartz glass is airtightly fixed to the opening 51. The shape of the opening 51 may not be circular but, for example, rectangular. A trap heating unit 54 for heating the trap element 48 is provided on an external side of the irradiation window 52 outside the housing 42. Specifically, the trap heating unit 54 has an infrared heater 56 made up of, e.g., an infrared halogen lamp heater, a carbon heater, or the like, and functions to heat the trap element 48 when necessary by irradiating infrared rays to the trap element 48 through the irradiation window 52.

An anti-adhesion shutter 58 is movably provided at an internal side of the irradiation window 52 inside the housing 42 to prevent adhesion of the exhaust to an inner surface of the irradiation window 52. When a preset process is performed on the wafer W and the exhaust is trapped from the exhaust gas, the anti-adhesion shutter 58 covers the inner surface of the irradiation window 52, thus preventing adhesion of the exhaust to the inner surface of the irradiation window 52. Further, the anti-adhesion shutter 85 moves to a position where the irradiation window 52 is not covered when the regeneration of the trap apparatus is carried out.

A coolant introducing unit 60 for introducing a coolant into the housing 42 is installed at a ceiling portion of the housing 42, and a coolant discharging unit 62 for discharging the coolant from the housing 42 is provided at a bottom portion of the housing 42. To elaborate, the coolant introducing unit 60 has a coolant inlet opening 64 provided at a ceiling portion of the housing 42. A coolant introducing pipe 68 having a coolant valve 66 is connected to the coolant inlet opening 64, whereby the coolant can be injected into the housing 42 when necessary. A liquid or a gas may be used as the coolant, and, especially, cooling water can be used as the liquid. Further, the coolant also serves as a cleaning solution for washing away broken exhaust as will be described later.

The coolant discharging unit 62 has a coolant outlet opening 70 provided at a bottom portion of the housing 42, and a discharging valve 71 for opening and closing the coolant outlet opening 70 is provided on the coolant outlet opening 70. The discharging valve 71 includes a hollow cylindrical body connected to the coolant outlet opening 70 and having a valve opening 74 at a lower end thereof; and a valve seat 72 having a ring-shaped flange provided at the outer periphery of the hollow cylindrical body. A sealing member 73 made of, e.g., an O-ring is provided at a bottom surface of the valve seat 72. As illustrated in FIG. 5, the valve opening 74 can be closed by the valve body 76. At this time, a gap between the valve seat 72 and the valve body 76 is airtightly sealed by the sealing member 73 provided at the valve seat 72. The valve body 76 can be moved vertically and rotated about a vertical axis by a driving mechanism (not shown), while serving to open or close the valve opening 74, as illustrated in FIGS. 5A and 5B.

The coolant discharge pipe 78 is disposed below the discharging valve 71 and is configured to discharge the coolant exhausted from the housing 42 to the outside of the system. The coolant discharge pipe 78 is connected to a valve box 79 (illustrated by a dashed dotted line) accommodating therein the valve seat 72 and the valve body 76.

Further, a cooling jacket 80 (see FIG. 3) is installed at the housing 42 of the trap apparatus 26 to cool the housing 42 to maintain a temperature (hereinafter, referred to as a “safety temperature”) causing no safety issue when the housing 42 is touched by a human (see FIG. 3). The coolant flows through the coolant jacket 80 when necessary. Further, fixed to the attachment pipe 36 (upstream portion of the attachment pipe 36 in the shown example) is an atmospheric pressure restoring gas introducing unit 82 (see FIG. 3) for bringing the inside of the housing 42 back to an atmospheric pressure when necessary by introducing a gas into the housing 42 (see FIG. 2).

To elaborate, the atmospheric pressure restoring gas introducing unit 82 includes an atmospheric pressure restoring gas pipe 84 connected to the attachment pipe 36, and an opening/closing valve 86 is installed at the atmospheric pressure restoring gas pipe 84 so as to supply a pressurized restoring gas when necessary. The restoring gas may be, for example, clean air or a N₂ gas. Here, when the restoring gas is supplied into the housing 42, it is preferable to perform the gas supply such that the internal pressure of the housing 42 is at a positive pressure level slightly higher than the atmospheric pressure, whereby contamination of the inside of the housing 42 due to an invasion of ambient air into the housing 42 can be prevented. Moreover, the atmospheric pressure restoring gas pipe 84 may be directly connected to the housing 42 without being connected to the attachment pipe 36.

Referring back to FIG. 1, an entire operation of the trap apparatus 26 is controlled by a controller 88 having, for example, a computer. The controller 88 is under the control of the apparatus controller 8 and performs a control so as to introduce the coolant into the housing 42 by the coolant introducing unit 60 in a state where the trap element 48 is heated by the trap heating unit 54 to thereby regenerate the trap element 48 by removing an exhaust captured by the trap element 48. The apparatus controller 8 includes a storage medium 90 which stores therein a computer program required for carrying out the above-stated control operation. The storage medium 90 may be a floppy disk, a CD (Compact Disk), a hard disk, a flash memory, or the like. Further, depending on generated reaction by-products, it may be preferable to heat the exhaust passage 22 by winding a tape heater on the exhaust passage 22 disposed between the exhaust port 20 and the trap apparatus 26, thus preventing adhesion of the exhaust to an inner wall of the exhaust passage 22 on the way to the exhaust port 20.

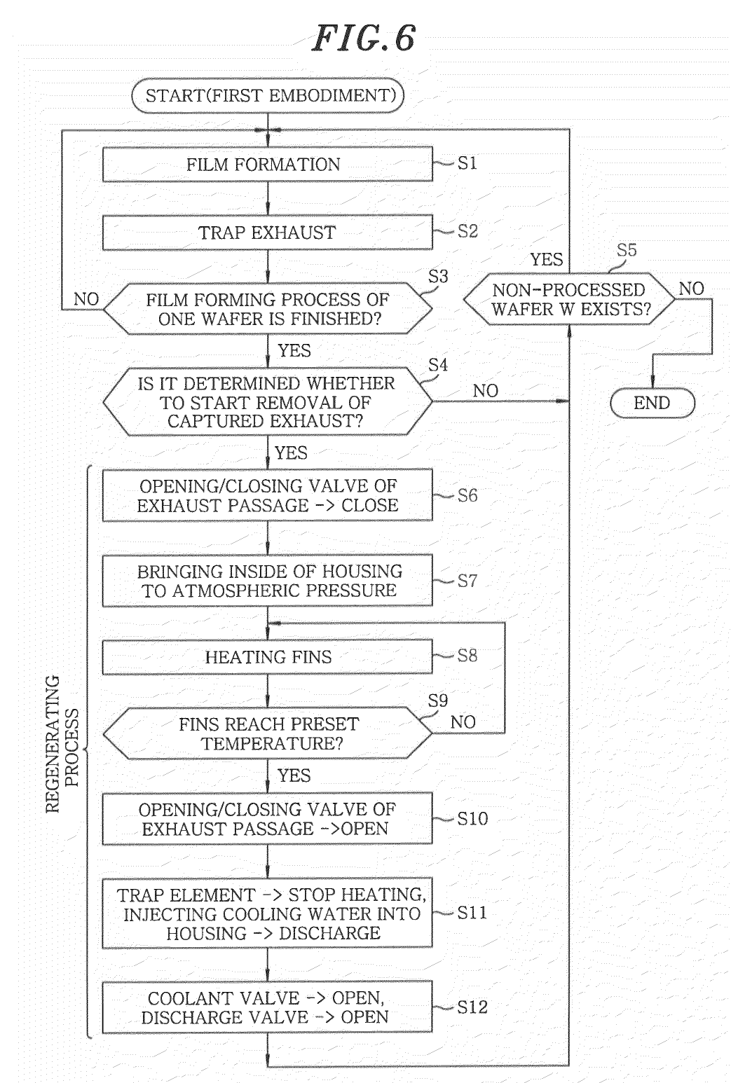

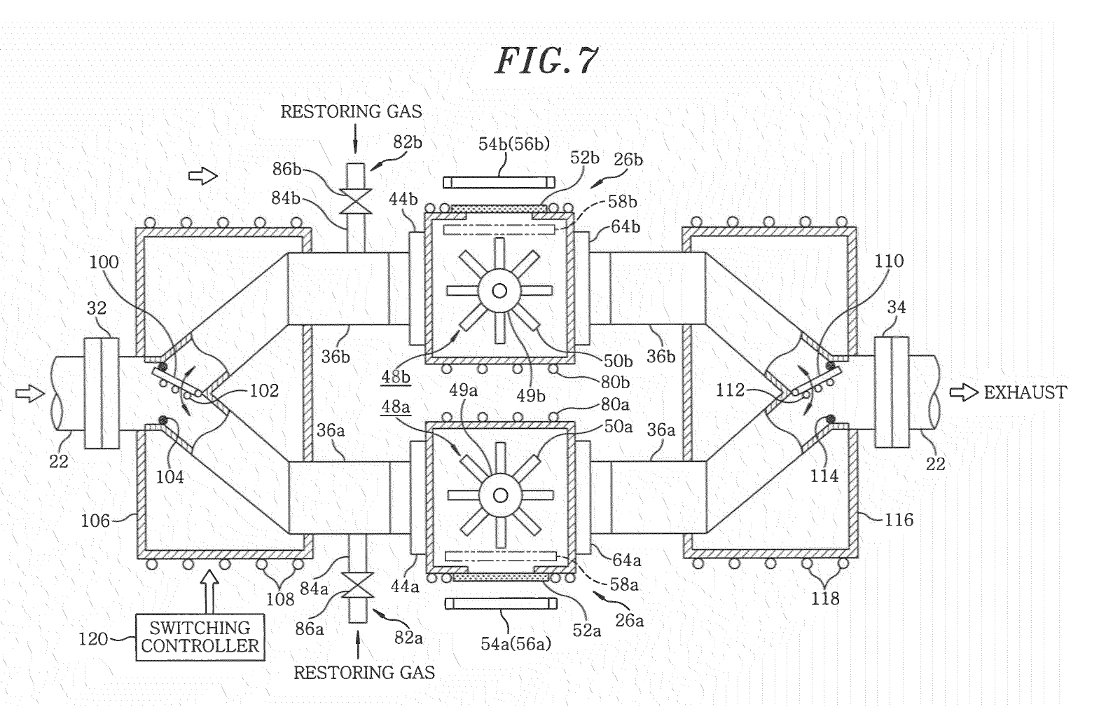

Now, an operation of the processing system 2 will be explained with reference to FIG. 6. FIG. 6 provides a flowchart to describe an entire operation of the processing system including the exhaust system using the trap apparatus in accordance with the first embodiment of the present invention.

First, as shown in FIG. 1, a semiconductor wafer W to be processed is loaded into the processing chamber 10 of the processing apparatus 4 and mounted on the mounting table 12. Then, the wafer W on the mounting table 12 is heated by the resistance heater 14 to a desired temperature and a predetermined gas is introduced from the shower head 18. At the same time, an internal atmosphere of the processing chamber 10 is evacuated to vacuum by the exhaust system 6, whereby the inside of the processing chamber 10 is maintained at a predetermined pressure. Then, a preset process is performed on the wafer W. If the preset process is, e.g., a film forming process, a film forming gas or the like may be introduced into the processing chamber 10 as a processing gas, whereby the film forming process is performed on the wafer W (step S1).

During the film forming process, the film forming gas remains in the processing chamber 10 and reaction by-products are generated therein, which are discharged from the processing chamber 10 while being mixed with an exhaust gas in the form of gaseous exhaust. Since the exhaust contained in the exhaust gas may cause various problems when they are directly discharged to the outside of the system, they are captured by the trap apparatus 26 provided in the exhaust system 6 (step S2). Specifically, the exhaust gas flowing in the exhaust passage 22 reaches the trap apparatus 26 via the pressure control valve 24 and is introduced into the housing 42 from the gas inlet 44 (see FIG. 2) of the housing 42. The exhaust gas introduced into the housing 42 is then brought into contact with the trap element 48 which is being rotated at a low speed, whereby the exhaust in the exhaust gas is captured by the surfaces of the fins 50 and removed from the exhaust gas.

Further, if a cooling jacket is further provided at the trap element 48 and the fins 50 are cooled by the cooling jacket, trapping efficiency of the exhaust may be further improved. The exhaust gas that the exhaust therein is removed in the above manner is then exhausted to the outside of the housing 42 from the gas outlet 46 and then reaches the exhaust gas abatement equipment 30 through the exhaust pump 28. In the exhaust gas abatement equipment 30, harmful substances contained in the exhaust gas are removed and is finally discharged to the atmosphere via a factory duct (not shown).

In the trap apparatus 26, the cooling jacket 80 provided at the housing 42 is operated to cool the housing 42 to the safety temperature, and the anti-adhesion shutter 58 is in a closed position inside the irradiation window 52, so that adhesion of the exhaust to the inner surface of the irradiation window 52 is prevented.

Such exhaust capturing (trapping) operation is performed until the film forming process of one wafer is completed (NO in step S3). If the process of the one wafer is finished (YES in step S3), it is determined whether to start a removal of the captured exhaust, i.e., whether to start a regenerating process of the trap apparatus (step S4). Such decision is made because the trapping efficiency may be reduced greatly if the amount of the exhaust captured by the trap element 48 is excessively increased. In general, for example, the regenerating process is performed every time one cassette (25 seats) of wafers W is processed. However, the frequency of the regenerating process is not limited to the above example, but timing for carrying out the regenerating process may be determined based on, e.g., a total amount of a film formation.

Here, when the regenerating process is not begun (No in step S4), it is determined whether a non-processed wafer W exists (step S5), and if there is no such a non-processed wafer W (No in step S5), the process is terminated. If a non-processed wafer W exists, however, the process returns to the step S1, and the above-described steps S1 to S5 are repeatedly performed. That is, wafers are consecutively processed. Then, if the amount of the exhaust captured by the trap element 42 increases and a decision for starting the removal of the capture exhaust, i.e., starting the regenerating process, is made (Yes in step S4), the trap apparatus 26 is isolated from the exhaust passage 22 by closing the opening/closing valves 38 and 40 provided upstream and downstream of the trap apparatus 26, respectively (step S6).

Then, a pressurized gas, e.g., pressurized air, is supplied from the atmospheric pressure restoring gas pipe 84 of the atmospheric pressure restoring gas introducing unit 82 into the housing 42, whereby the inside of the housing 42 is brought back to the atmospheric pressure (step S7). In such case, the inside of the housing 42 is maintained in a positive pressure state slightly higher than the atmospheric pressure to prevent contamination, thus suppressing an inflow of an external atmosphere into the housing 42. Here, in case that harmful substances are captured by the trap apparatus 26, it may be preferable to maintain the inside of the housing 42 in a negative pressure state slightly lower than the atmospheric pressure in the reverse manner as described above to prevent a leakage of an harmful gas from the trap apparatus 26.

After or concurrently with the above-described atmospheric pressure restoring operation, the anti-adhesion shutter 58 covering the irradiation window 52 is driven to be retreated from the current position in front of the irradiation window 52. Then, the trap heating unit 54 is operated, and infrared rays are radiated toward the trap element 48 from the infrared heater 56. Thus, the infrared rays are irradiated to the trap element 48 within the housing 42 after transmitted through the irradiation window 52, so that the trap element 48 is heated (step S8). The irradiation of the infrared rays is performed until the trap element 48 including the fins 50 reaches a preset temperature (No in step S9). The preset temperature is, e.g., about 600° C., at which the exhaust may be physically broken up and collapsed when a rapid cooling process is performed subsequently, though it may be varied depending on the kind of the exhaust.

Further, when the fins 50 are heated, the exhaust adhered to the fins 50 may be sublimated by the heating and adhered to the inner surface of the irradiation window 52. In such case, a shower nozzle or the like may be provided in the housing 42 to prevent adhesion of the sublimated material(S) by flowing cleaning water or the like on the inner surface of the irradiation window 52 from the shower nozzle when the fins 50 are heated. In such case, it is preferable to use a near infrared heater as the trap heating unit 54 capable of radiating light in a wavelength range of near infrared rays because it suffers a less amount of heat absorption by the cleaning water.

If the trap element 48 reaches the predetermined temperature, the valve body 76 of the discharging valve 71 provided at the bottom portion of the housing 42 is opened, whereby the valve opening 74 is opened as well (step S10). At the same time, the heating of the trap element 48 is stopped. Further, the coolant valve 66 of the coolant introducing pipe 68 in the coolant introducing unit 60, which is provided at the ceiling portion of the housing 42, is concurrently opened, whereby a large amount of a coolant, e.g., cooling water, is injected into the housing 42 from the coolant inlet opening 64 and discharged into the coolant discharge pipe 78 via the coolant outlet opening 70 and the discharging valve 71 (step S11). The opening/closing operation of the discharging valve 71 is illustrated in FIGS. 5A and 5B.

At this time, since the trap element 48 including the fins 50 heated to, e.g., about 600° C. and the exhaust adhered thereto are rapidly cooled by the cooling water introduced into the housing 42, the hard exhaust captured by the fins 50 may be cracked due to a difference in linear expansion coefficient between the exhaust and the fins 50, so that the exhaust is physically broken up and collapsed and finally peeled off the fins 50. Therefore, the exhaust adhered and solidified on the trap element 48 can be successfully removed from the trap element 48, and the trap element 48 can be regenerated. Here, the peeled-off exhaust is discharged into the coolant discharge pipe 78 along with the cooling water. Here, it may be also preferable to repeatedly perform the heating of the fins 50 and the introduction/discharge of the cooling water multiple times.

Upon the completion of the regenerating process of the trap element 48, processing of a next wafer W is prepared. First, the coolant valve 66 is closed to stop the supply of the cooling water and the discharging valve 71 is closed concurrently (from the state in FIG. 5B to the state of FIG. 5A), so that the inside of the housing 42 is sealed (step S12). When the discharging valve 71 is closed, the cooling water including the broken-up exhaust does not flow to the sealing member 73 since the valve seat 72 is formed in a flange shape and the sealing member 73 is located at a position apart from the valve opening 74 as shown in FIGS. 2 and 5. Moreover, since the valve body 76 is retreated in horizontal direction, the discharged cooling water does not flow to a sealing surface of the valve body 76. Accordingly, the discharging valve 71 can be highly airtightly closed without being disturbed by foreign materials.

Further, since the attachment pipe 36 is curved downward in the substantially U-shape as a whole and the housing 42 is installed at bottommost portion of the attachment pipe 36, an outflow of the cooling water to the upstream or downstream of the exhaust passage 22 via the attachment pipe 36 can be prevented even when a large amount of cooling water is introduced into the housing 42.

In addition, though the coolant valve 66 and the discharging valve 71 are closed at the same time at the step S12, the present invention is not limited thereto. For example, after only the water coolant valve 66 is closed and the supply of the cooling water is stopped, the trap heating unit 54 may be re-operated, thus heating and drying the fins 50 by heat rays. In such case, moisture generated by the drying process is discharged via the discharging valve 71, and if such drying process is completed after a preset period of time, the discharging valve 71 is closed.

If the regenerating process of the trap apparatus from the steps S6 to S12 is completed, as described above, the opening/closing valves 38 and 40 respectively provided upstream and downstream of the trap apparatus 26 are opened, and the processing of the wafer W is restarted. That is, if there remains a wafer W yet to be processed (Yes in step S5), the process returns back to the step S1 and the above-described respective processing steps are repeatedly performed. On the other hand, if there remains no non-processed wafer W and the processing thereof is completed (No in step S5), the entire operation of the processing system is terminated.

In accordance with the first embodiment described above, when the exhaust contained in the exhaust gas is captured by the trap element 48 and removed therefrom, the trap element 48 and the adhered exhaust are rapidly cooled by the coolant introduced from the coolant introducing unit 60. Due to a difference in linear expansion coefficient between the trap element 48 and the adhered exhaust, and a heat contraction rate, so that the adhered exhaust can be physically broken up and clearly removed. Thus, the regeneration of the trap apparatus can be successfully carried out.

### Explanation of an Exhaust System in Accordance with a Second Embodiment

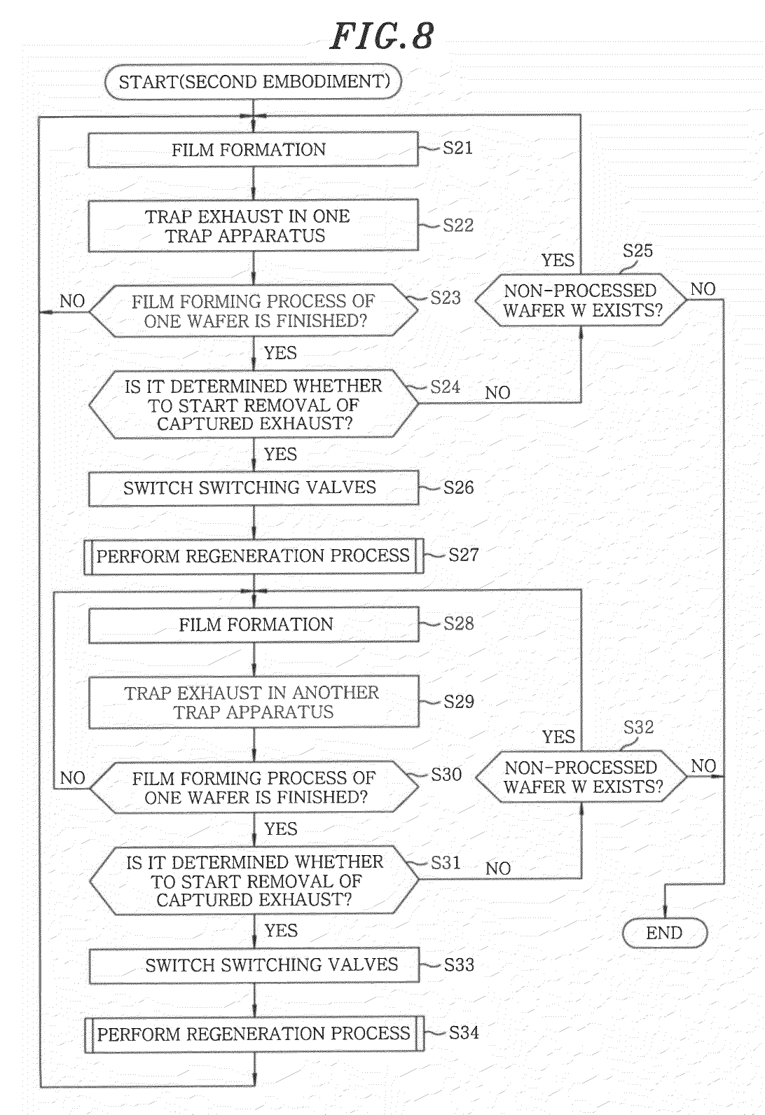

Below, an exhaust system in accordance with a second embodiment of the present invention will be explained. FIG. 7 is a partial cross-sectional top view of trap apparatuses installed in the exhaust system in accordance with the second embodiment of the present invention. Throughout FIGS. 2 and 3, like reference numerals are used for like or corresponding parts, and redundant description thereof will be omitted. Since a side view of each trap apparatus is substantially same as that shown in FIG. 2, illustration thereof will be omitted herein.

In the exhaust system of the second embodiment, plural, e.g., two trap apparatuses in this example can be installed. The two trap apparatuses are switched such that exhaust is trapped by one trap apparatus while a regenerating process is being performed on a trap element 48 of the other trap apparatus. Thus, a consecutive operation of the processing system is enabled. That is, in this second embodiment, an exhaust passage 22 branches off into plural passages, e.g., two passages in this example to which two attachment pipes 36a and 36b are respectively attached. Upstream ends of the attachment pipes 36a and 36b are connected to each other to form a branch part, while downstream ends of the attachment pipes 36a and 36b are connected to each other to form a junction part.

Like the attachment pipe 36 of the first embodiment, the attachment pipes 36a and 36b are installed at a horizontally extending portion of the exhaust passage 22 and are curved in the direction of gravity (downward) in a U-shape or a square bracket shape. Trap apparatuses 26a and 26b each having the same configuration as that of the trap apparatus 26 described in the first embodiment are installed at bottommost portions of the attachment pipes 36a and 36b, respectively. The trap apparatuses 26a and 26b are configured completely same excepting that they are arranged reversely in a left-right direction with respect to the flow direction of the exhaust gas. In FIG. 7, as for the same components as those of the trap apparatus 26 of the first embodiment, “a” is added to the end of reference numerals of corresponding components of one trap apparatus 26a, while “b” is added to the end of reference numerals of corresponding components of the other trap apparatus 26b, and redundant description is omitted.

An upstream switching valve 100 is provided at the branch part upstream of the attachment pipes 36a and 36b and is configured to open either one of them while blocking the other. FIG. 7 illustrates a state in which the attachment pipe 36a is opened. A valve heating unit 102 made up of a heater is installed at the upstream switching valve 100, and it becomes possible to prevent the exhaust in an exhaust gas from adhering to the valve 100 by way of heating the upstream switching valve 100.

Further, a sealing member 104 made of a metal seal or an O-ring is provided at a portion that brings into contact with the upstream switching valve 100 on the inner peripheral surface of the branch part to airtightly seal an inlet of an attachment pipe to be blocked. Further, the entire outside of the branch part is enclosed by a casing 106. A cooling jacket 108 is provided in the casing 106 to reduce the temperature of the branch part to a safety level while preventing the sealing member 104 from being deteriorated by a heat. The junction part downstream of the attachment pipes 36a and 36b is configured as in the same manner as the branch part.

That is, a downstream switching valve 110 is installed at the junction part downstream of the attachment pipes 36a and 36b and is configured to open either one of them while blocking the other. FIG. 7 illustrates the state in which the attachment pipe 36a is opened. A valve heating unit 112 made up of a heater is installed at the downstream switching valve 110, and it becomes possible to prevent the exhaust in the exhaust gas from adhering to the valve 110 by way of heating the downstream switching valve 110.

Further, a sealing member 114 made of a metal seal or an O-ring is provided at a portion that brings into contact with the downstream switching valve 110 on the inner peripheral surface of the junction part to airtightly seal an outlet of the attachment pipe to be blocked. Further, the entire outside of the junction part is enclosed by a casing 116. A cooling jacket 118 is provided in the casing 116 to reduce the temperature of the junction part to a safety temperature while preventing the sealing member 114 from being deteriorated by a heat.

The switching valves 100 and 110 are controlled by a switching controller 120 having a computer or the like and synchronously switched in the same direction at the same time. As a result, while the regeneration is performed in either one of the two trap apparatuses 26a and 26b, the exhaust gas is allowed to flow in the other trap apparatus.

Hereinafter, an operation of the exhaust system in accordance with the second embodiment will be explained with reference to FIG. 8. FIG. 8 provides a flowchart to describe an entire operation of a processing system including the exhaust system having the trap apparatuses in accordance with the second embodiment of the present invention. First, the upstream switching valve 100 and the downstream switching valve 110 respectively installed at the branch part and junction part of the attachment pipes are operated, so that either one of the two attachment pipes 36a and 36b, e.g., the attachment pipe 36b, is blocked by closing the upstream and downstream sides thereof, while the other attachment pipe 36a is opened and the trap apparatus 26a installed therein is set in an operation mode (exhaust trapping mode).

First, a film forming process is performed on a wafer W in the processing apparatus 4 (see FIG. 1) (step S21), and exhaust in an exhaust gas is trapped in the trap apparatus 26a (step S22), and this operation is continued until the processing of the one wafer W is completed (step S23). Then, it is determined whether to start a removal of the captured exhaust, i.e., whether to start a regenerating process, whenever one wafer is processed (step S24). If the amount of the capture exhaust is small (No in step S24), a presence of a non-processed wafer W is checked (step S25). If there remains no wafer W yet to be processed (No in step S25), the process is terminated.

However, if a non-processed wafer W exists (Yes in step S25), the processing steps S21 to S25 are repeatedly performed, as in the same manner as the processing steps S1 to S5 shown in FIG. 6. Further, while the exhaust is being captured by the trap apparatus 26a as described above, a regenerating process as described in the steps S6 to S12 shown in FIG. 6 is performed in the other trap apparatus 26b. Afterward, the trap apparatus 26b is set in a standby mode for a next exhaust trapping operation.

Then, if the amount of the captured exhaust becomes great and a decision for starting the removal of the captured exhaust, i.e., starting the regenerating process, is made (Yes in step S24), the upstream switching valve 100 and the downstream switching valve 110 are switched to open the attachment pipe 36b (step S26). Then, the exhaust gas is made to flow into the trap apparatus 26b which is in the standby mode after the completion of the regenerating process. Accordingly, the trap apparatus 26a being set in the operation mode is isolated from the flow of the exhaust gas, and the regenerating process as described in the steps S6 to S12 shown in FIG. 6 is then performed on the trap apparatus 26a (step S27).

Concurrently with this regenerating process, the switched trap apparatus 26b is set in an operation mode and the film forming process and trapping process described in the steps S28 to S32, which are the same processes as described in the steps S21 to S25, are repeatedly performed. Here, if a decision for starting a regenerating process is made due to an increase of the captured exhaust in the trap apparatus 26b (Yes in step S31), the upstream switching valve 100 and the downstream switching valve 110 are switched so as to select the attachment pipe 36a again (step S33). Then, the exhaust gas is flown into the trap apparatus 26a which is in a standby mode after the completion of the regenerating process.

Accordingly, the trap apparatus 26b being set in the operation mode is isolated from the flow of the exhaust gas, and the regenerating process as described in the steps S6 to S12 shown in FIG. 6 is then performed on the trap apparatus 26b (step S34). Concurrently with this regenerating process, the switched trap apparatus 26a is set back to the operation mode, and the film forming process and trapping process of the steps S21 to S25 are repeatedly performed. The above-described process is performed until there remains no wafer W yet to be processed. As described above, the two trap apparatuses 26a and 26b are switched to perform the exhaust trapping process and the regenerating process alternately, so that consecutive processing of wafers W can be carried out.

Further, since no sliding portion for switchover is used when the two trap apparatuses 26a and 27b are switched, a leakage of the exhaust gas or cooling water (cleaning water) to the outside can be prevented when they are switched. Further, since the upstream switching valve 100 and the downstream switching valve 110 are heated by the valve heating units 102 and 112, respectively, adhesion of the exhaust to each of the switching valves 100 and 110 can be prevented.

As described, by branching off the exhaust passage 22 in a plural number, e.g., two, the two attachment pipes 36a and 36b are provided, and the trap apparatuses 26a and 26b are installed at the attachment pipes respectively. By switching the attachment pipes 36a and 36b, the operation and regeneration of the trap apparatuses 26a and 26b can be alternately switched. With this configuration, it is not necessary to provide a sliding portion, and a leakage of the exhaust gas, the coolant (cleaning water) or the like can be suppressed. Moreover, the processing system can be operated consecutively.

Further, though the attachment pipe 36 is branched off in two in the above-described example, the present invention is not limited thereto. For example, three or more branched attachment pipes may be used and a trap apparatus may be installed at each of the attachment pipes. Further, in the above-described example, though the infrared heater 56 provided outside the housing 42 is used as the trap heating unit 54, it may be also possible to fix a resistance heater to the trap element 48 without being limited thereto.

A film formed by the film forming process performed by the processing apparatus 4 may be of various kinds such as, but not limited to, a silicon oxide film, a ceramic film such as alumina (Al₂O₃), a metal film such as Ta, Ti and W (tungsten), a metal fluorine film such as MgF₂ and CaF, but not limited thereto. Furthermore, the process performed by the processing apparatus 4 may not be limited to the film forming process, and the present invention can also be applied to any process accompanying generation of gaseous exhaust such as a reaction by-product and/or a residual source gas. Such a process may be, for example, a tungsten etching process, a titanium etching process, a titan nitride etching process, or the like.

In such case, it is desirable to determine a material for forming the fins 50 of the trap element 48 depending on the kind of the exhaust, and it may be preferable to select a material having corrosion resistance and having a linear expansion coefficient greatly different from that of the exhaust (deposits on the fins 50). For example, in case that the exhaust is Si or SiO₂, stainless steel may be preferably used as the material for the fins 50, and in case that the exhaust is CaF₂, a titanium alloy or incoloy may be preferably used as the materials for the fins 50. Further, in case that the exhaust is NH₄Cl, hastelloy or a titanium alloy may be preferably used as the material for the fins 50.

Further, the efficiency of capturing (trapping) the exhaust can be further improved by providing a cooling unit in the trap element 48 and cooling the trap element 48 with the cooling unit. In addition, the target object processed by the processing apparatus 4 may not be limited to the semiconductor wafer, but another kind of substrate such as a glass substrate, a LCD substrate, and a ceramic substrate can also be used.

What is claimed is:

1. A trap apparatus provided in an exhaust passage for discharging an exhaust gas from a processing chamber which processes a target object, and configured to capture exhaust from the exhaust gas, the apparatus comprising:
a housing installed in the exhaust passage;
a trap element provided in the housing, for capturing the exhaust;
a trap heating unit for heating the trap element;
a coolant introducing unit for introducing a coolant into the housing;
a coolant discharging unit for discharging the coolant from the housing; and
a controller for controlling the trap heating unit and the coolant introducing unit such that the coolant is introduced into the housing by the coolant introducing unit in a state where the trap element is heated by the trap heating unit to remove the exhaust captured by the trap element.

2. The trap apparatus of claim 1, wherein a transparent irradiation window is provided at the housing, and the trap heating unit includes an infrared heater provided on an external side of the irradiation window outside the housing.

3. The trap apparatus of claim 2, wherein an anti-adhesion shutter for preventing an adhesion of the exhaust to a surface of the irradiation window is movably installed on an internal side of the irradiation window inside the housing.

4. The trap apparatus of claim 1, wherein the trap heating unit includes a resistance heater provided at the trap element.

5. The trap apparatus of claim 1, wherein the coolant introducing unit has a coolant inlet opening provided at a ceiling portion of the housing, and the coolant is injected to the trap element from the coolant inlet opening.

6. The trap apparatus of claim 1, wherein the coolant discharging unit is installed in a bottom portion of the housing, and an opening/closing valve configured to be opened and closed is provided at a coolant discharge opening of the coolant discharging unit.

7. The trap apparatus of claim 6, wherein the opening/closing valve includes a valve body, a flange-shaped valve seat provided at an outer periphery of a valve opening to accommodate the valve body thereon, and a sealing member for airtightly sealing a gap between the valve seat and the valve body is provided at the valve seat.

8. The trap apparatus of claim 1, wherein a cooling jacket is provided at an outer periphery of the housing.

9. The trap apparatus of claim 1, further comprising an atmospheric pressure restoring gas introducing unit for introducing an atmospheric pressure restoring gas into the housing.

10. The trap apparatus of claim 1, wherein the trap element has fins.

11. The trap apparatus of claim 10, wherein the fins are rotatable.

12. The trap apparatus of claim 10, wherein the fins are made of a material selected depending on a kind of the exhaust.

13. An exhaust system comprising:
an exhaust passage for discharging an exhaust gas from a processing chamber for processing a target object;
the trap apparatus of claim 1 installed in the exhaust passage;
an exhaust gas abatement equipment for removing a harmful substance in the exhaust gas that has passed through the trap apparatus; and
an exhaust pump installed at the exhaust passage, for suctioning an atmosphere within the processing chamber.

14. The exhaust system of claim 13, wherein the trap apparatus is installed at an attachment pipe provided in the exhaust passage, and the attachment pipe is curved in a direction of gravity such that the trap apparatus is located at a position lower than a joint portion of the exhaust passage to the attachment pipe.

15. An exhaust system comprising:
an exhaust passage for discharging an exhaust gas from a processing chamber for processing a target object;
two or more attachment pipes installed on the exhaust passage in parallel to each other;
the trap apparatus of claim 1 installed in each attachment pipe;
a switching valve provided at each of a branch part and a junction part of the attachment pipes, for allowing at least one of the attachment pipes to communicate with the exhaust passage, while allowing at least one of the other attachment pipes to be isolated from the exhaust passage;
an exhaust gas abatement equipment for removing a harmful substance in the exhaust gas that has passed through the trap apparatus;
an exhaust pump installed at the exhaust passage, for suctioning an atmosphere within the processing chamber; and
a switching controller for controlling the trap apparatuses and the switching valve such that an operation for trapping the exhaust from the exhaust gas is performed in said at least one of the trap apparatuses while an operation for removing the adhered exhaust from said at least one of the other trap apparatuses is being performed.

16. An exhaust system of claim 15, wherein a valve heating unit for heating the switching valve is provided at the switching valve to prevent an adhesion of the exhaust in the exhaust gas to the switching valve.

17. The exhaust system of claim 15, further comprising a cooling jacket for cooling the branch part and the junction part.

18. The exhaust system of claim 15, wherein each attachment pipe is curved in a direction of gravity so as to locate the trap apparatus, which is provided in the corresponding attachment pipe, lower than a joint portion of the attachment pipe to the exhaust passage.

19. A processing system comprising:
a processing apparatus having a processing chamber for processing a target object; and
the exhaust system of claim 13.

20. A processing system comprising:
a processing apparatus having a processing chamber for processing a target object; and
the exhaust system of claim 15.
